(19) United States
(12) Patent Application Publication
(10) Pub. No.: US 2018/0175656 A1
(43) Pub. Date: Jun. 21, 2018

(54) Systems and methods for mobile device energy transfer

(71) Applicant: Brandon Kelly, Sandy Springs, GA (US)

(72) Inventor: Brandon Kelly, Sandy Springs, GA (US)

(21) Appl. No.: 15/732,711

(22) Filed: Dec. 18, 2017

Related U.S. Application Data
(60) Provisional application No. 62/435,724, filed on Dec. 17, 2016.

(51) Int. Cl. H02J 7/02; H04B 1/3827; H04W 12/06; H02J 7/00; H02J 50/12

(52) U.S. Cl. CPC H02J 7/025; H04B 1/3827; H04W 12/06; H02J 50/12; H02J 7/0068; H02J 7/0047; H02J 7/0054

(57) ABSTRACT

Exemplary embodiments are provided for executing wireless energy transfer between network-connected mobile devices. The method may include receiving an energy transfer request from a recipient mobile device (RMD) connected to a network. The network may broadcast a notification to a donor mobile device (DMD) connected to the network and determined to be within a pre-defined proximity of the RMD. The network may receive an authorization from the DMD indicating consent to the energy transfer request. Location data comprising a location may be sent to the DMD and the RMD to enable a meetup to occur. The network may determine that the DMD and the RMD are at the location and transmit a signal to the DMD causing a first energy transducer electrically coupled to a first battery of the DMD to transfer a first electric energy to a second energy transducer electrically coupled to a second battery of the RMD.

### RELATED APPLICATIONS

This application is based upon and claims priority to and benefit of U.S. provisional patent application Ser. No. 62/435,724, filed Dec. 17, 2016. The entire content of the aforementioned application is expressly incorporated herein by reference.

### BACKGROUND

Mobile device (e.g., smartphones, tablets, and media players) users have exponentially increasing uses for their devices since mobile devices were introduced in the electronics industry. Increased demands in battery performance have come along with the increasing use. Although battery technologies have tremendously improved within the past decade, there is still a need for the ability to recharge mobile device batteries before they become fully expended. In addition to improved battery technologies, portable cell phone power banks have allowed mobile device users to recharge their devices in the event an AC outlet is not readily available from which to draw a charging current. But portable cell phone power banks are still relatively costly accessories and add to the number of devices a user must carry around with them. Mobile device users would greatly benefit from access to other sources of energy to recharge their device, especially when no other customary source of energy is readily available.

### SUMMARY

The present disclosure relates generally to systems, methods and computer readable media for executing the transfer of energy between mobile devices. The method for executing wireless energy transfer between mobile devices may include a network receiving an energy transfer request from a recipient mobile device (RMD) in communication with the network. In response to receiving the energy transfer request from the RMD, the network may broadcast a notification to a donor mobile device (DMD) in communication with the network, wherein the DMD may be within a pre-defined proximity of the RMD. The notification may be generated in response to the network receiving the energy transfer request from the RMD. After broadcasting the notification to devices in communication with the network, the network may then receive an authorization from at least one DMD. The authorization may be an affirmative reply by the DMD to indicate consent to the energy transfer request issued by the RMD. The network, upon receiving the authorization from the DMD, may then transmit the authorization or some data corresponding to the authorization to the RMD, indicating that the energy transfer request has been accepted by a DMD. The network may, upon determining that the authorization is received by the RMD, transmit location data to the DMD and the RMD, wherein the location data may indicate a location where the RMD user and the DMD user can meet to perform the energy transfer. It may then be determined that the DMD and the RMD are at the location, wherein a signal may be transmitted to the DMD to cause a first energy transducer to transfer a first electric energy to an energy transducer of the RMD.

The first energy transducer may be electrically coupled to a battery of the DMD. The second energy transducer may be electrically coupled to a battery of the RMD. The first electric energy stored in the first battery may be discharged into an inductive coil electrically coupled to the DMD battery, wherein the inductive coil may generate a magnetic energy field or magnetic energy around the coil. The magnetic energy emanates from the DMD, and when placed adjacent to the RMD, the energy transducer of the RMD may include an inductive coil that may detect the magnetic energy emanating from the DMD. The energy transducer of the RMD may convert the detected magnetic energy to electric energy and may then transfer the converted electric energy to the battery of the RMD. Transferring the converted electric energy to the battery of the RMD results in the RMD battery being charged.

### BRIEF DESCRIPTION OF DRAWINGS

Some embodiments are illustrated by way of example in the accompanying drawings and should not be construed to limit the present disclosure.

FIG. 1 is a block diagram of network connected devices for executing wireless energy transfer between mobile devices, according to an example embodiment.

FIG. 2 illustrates an exemplary mobile device for wireless energy transfer, according to an example embodiment.

FIG. 3 is a block diagram of network connected mobile devices with inductive coils executing a wireless energy transfer, according to an example embodiment.

FIG. 4 is a flowchart showing a method for executing a wireless energy transfer between mobile devices, according to an example embodiment.

FIG. 5 is a flowchart showing another method for executing a wireless energy transfer between mobile devices, according to an example embodiment.

FIG. 6 is a block diagram of an exemplary computing device that may be used to implement exemplary embodiments of the mobile device wireless energy transfer system described herein, according to an example embodiment.

### DETAILED DESCRIPTION

Described in detail herein are methods, systems, and computer readable medium for executing wireless energy transfer between mobile devices via a network. Example embodiments provide a donor mobile device (DMD) connected to a network. The DMD may include a battery or energy storage device to provide electric power to the DMD. The battery may be electrically coupled to an energy transducer, wherein the energy transducer may be configured to convert electric energy into magnetic energy or convert magnetic energy to electric energy. Example embodiments may also provide a recipient mobile device (RMD) connected to the network. The RMD may include a battery or energy storage device to provide electric power to the RMD. The DMD and RMD may be identical devices and may only differ in the way in which they operate. For example, the DMD and the RMD may both be mobile devices, but the DMD may be in a discharge mode to discharge energy from the battery of the DMD, and the RMD may be in a recharge mode to receive energy from an energy discharging device, according to example embodiments described herein.

Further in this example embodiment, the RMD may transmit an energy transfer request, via a communication connection with the network. The network may be in communication with one or more DMDs that are determined to be available to respond to the energy transfer request. The network may then broadcast a notification to the one or more DMDs, wherein at least on DMD receives a notification corresponding to the energy transfer request. The network may then receive an authorization from the DMD in response to the energy transfer request. When the DMD transmits the authorization, the authorization informs the network that the DMD consents to responding to the energy transfer request issued by the RMD. The network may then provide location data to the RMD and the DMD, wherein the location indicates where the RMD user and the DMD user can meet with their respective mobile devices to perform the energy transfer transaction. When it is determined that the DMD and the RMD are at the location, the DMD may receive a signal, from the network or from a network connected device, to cause the first energy transducer of the DMD to transfer electric energy to the second energy transducer.

According to an example embodiment, electric energy or voltage may be stored in the battery of the DMD, wherein the battery is electrically coupled to the energy transducer that converts electric energy to magnetic energy. For example, the electric energy in the battery can be discharged to a coil that is electrically coupled to the battery. The discharge occurs when electrons move from the battery to a load or some component (e.g., coil, conductor) that accepts the electrons. When the electric energy is discharged to the coil, a magnetic energy field is generated around the coil. This phenomenon may be described by the principles of electromagnetics. For example, when electric current is passed through the wire of a coil, a magnetic field is generated around the coil. Conversely, an external time-varying magnetic field that penetrates the interior of a coil generates an electromagnetic field (EMF) or voltage in a conductor coupled to the coil.

According to an example embodiment, the RMD may include an energy transducer having a coil configured to detect a magnetic field that is proximate to the coil. Electric energy may be transferred when the energy transducer of the DMD generates the magnetic field and is placed adjacent to or proximate to the energy transducer of the RMD. By being within range of the magnetic field generated by the DMD energy transducer, the RMD energy transducer detects the magnetic field, which generates a current in the RMD energy transducer coil. The current generated in the coil may be applied to the battery of the DMD, which results in the DMD battery being charged.

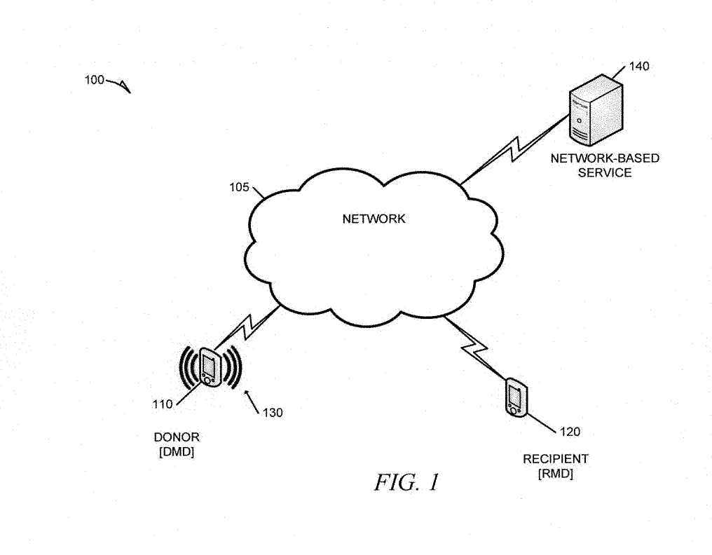

FIG. 1 illustrates a system 100 for executing wireless energy transfer between network connected mobile devices. In an example embodiment, a donor mobile device (DMD) 110 and a recipient mobile device (RMD) 120 may be connected to a network 105 that provides a network-based service 140. The DMD 110 and RMD 120 may include a battery unit or energy storage device. The battery may be electrically coupled to an energy transducer for converting electric energy stored in the battery to magnetic energy 130. In this example embodiment, the RMD 120 may transmit an energy transfer request to the network 105 to indicate that the RMD would like to receive a battery recharge. Upon receiving the energy transfer request from the RMD 120, the network 105 may broadcast a notification to at least one DMD 110 connected to the network. There may be a plurality of DMDs connected to the network, all of which may receive the notification from the network, the notification corresponding to the energy transfer request. In response to at least one DMD 110 receiving the notification, the DMD 110 may transmit an authorization to the network 105 to indicate that a user of the DMD 110 consents to the energy transfer request. When the network 105 receives the notification from the DMD 110, the network 105 may send location data to the DMD 110 and the RMD 120, wherein the location data may include a location.

The location may correspond to a geographical location of a business, building, address, or public space, for example. The location data may also include instructions on how to get to the location. For example, the location data may include directions to the location. The location data may also include instructions to direct the user(s) of the RMD 120 or DMD 110 on how to identify the user of the other DMD 110 or RMD. For example, the location instructions may include a description of the user by identifying characteristics of the user (e.g., gender, race, physical size, or wardrobe). The location instructions may also include details about the geographical location to help the user narrow down the location of the user to a more specific location within the general location. For example, the location may be a restaurant or bar on Main Street and the narrowing details may be at the beer tap inside the restaurant or bar on Main Street.

Once it is determined that the DMD 110 and the RMD 120 are at the location, the DMD 110 may receive a signal that causes electric energy to transfer from the DMD 110 to the RMD 120. In other words, the network 105 may receive data from the RMD 120 or the DMD 110 indicating to the network that the DMD 110 and the RMD 120 are at the location and are within a proximity of each other in order to execute the transfer of energy from the DMD 110 to the RMD 120. For example, if the DMD 110 and the RMD 120 are within a pre-defined distance from each other, the DMD 110 or the RMD 120 may receive instructions on how to physically align the RMD 120 and DMD 110 to begin the energy transfer process.

The energy transfer process may begin when the energy transducer of the DMD 110 is energized by discharging electric energy, as a current, from the battery into the coil of the energy transducer. Energizing the coil with an electric current generates a magnetic field or magnetic energy 130 around the coil. The magnetic energy 130 may be generated when electric energy is discharged from the battery to the energy transducer. If the energy transducer of the RMD is placed adjacent to or proximate to the magnetic energy field 130, an electric current can be generated in the coil of the RMD's energy transducer. The electric current in the RMD's energy transducer may then be applied to the RMD's battery, which may result in the battery being recharged by receiving the generated electric current.

According to this example embodiment, a network-based service 140 may manage how the energy transfer transaction is executed. For example, the network-based service may control all systems and processes of the network 105 by receiving and transmitting data to and from network-connected devices (e.g., DMDs, RMDs). The network-based service 140 may also determination when and how to perform communications and transactions between the network-connected devices. For example, the network-based service 140 may control which RMDs and DMDs can be connected to the network 105 by requesting information corresponding to each network-connected device and authenticating the network connected device. Authentication may occur by the network-based service 140 comparing device information with information stored in a database in communication with the network 105.

The network-based service may also automatically enable the wireless transfer of energy between mobile devices. For example, the network 105 may determine that the battery of the RMD is below a pre-defined threshold and automatically send an energy transfer request to at least one DMD that is connected to the network 105. The network-based service 140 may determine that the DMD is in a discharge mode and automatically determine that the DMD consents to an authorization to transfer energy to the RMD at least based on the DMD being in the discharge mode.

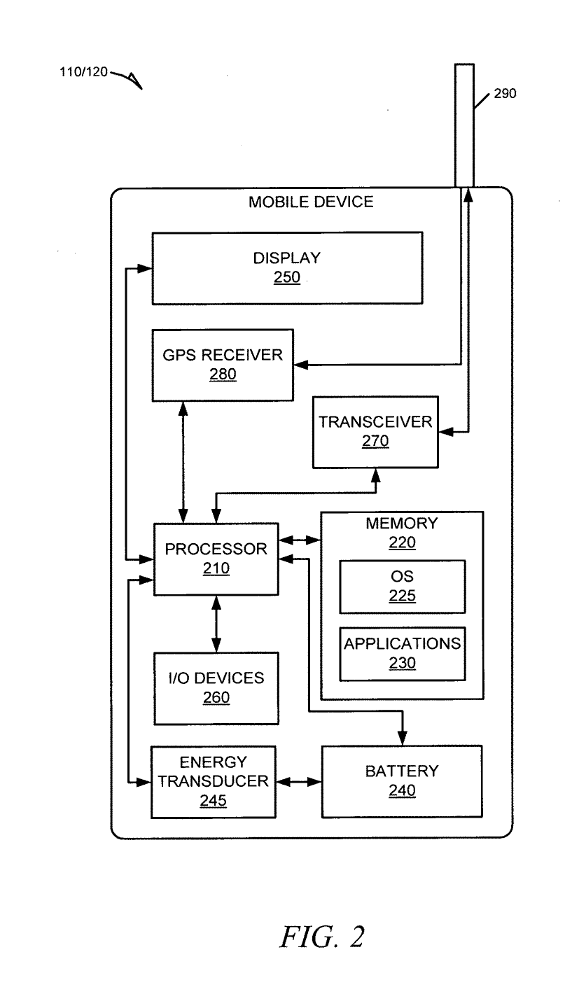

FIG. 2 is a block diagram illustrating a mobile device for implementing systems and methods associated with executing wireless energy transfer between mobile devices, according to an example embodiment. In an example embodiment, the mobile device 110/112 includes one or more processor(s) 210, a memory 220, a battery 240, an energy transducer 245, a display 250, I/O devices 260, a transceiver 270, a GPS receiver 280 and an antenna 290. The processor(s) 210 may be any of a variety of different types of commercially available processors suitable for mobile devices (for example, NVIDIA System on a Chip (SoC) multicore processors along with graphics processing units (GPU) devices, such as the Tegra K-1, XScale architecture microprocessors, Intel® Core™ processors, Intel® Atom™ processors, Intel® Celeron® processors, Intel® Pentium® processors, Qualcomm® Snapdragon processors, ARM® architecture processors, Microprocessor without Interlocked Pipeline Stages (MIPS) architecture processors, Apple® A series System-on-chip (SoCs) processors, or another type of processor). The processor(s) 210 may also include one or more graphics processing units (GPUs) (not shown). The memory 220, such as a Random Access Memory (RAM), a Flash memory, or other type of memory, is accessible to the processor(s) 210. The memory 220 can be adapted to store an operating system (OS) 75, as well as application programs 80, such the retinopathy workflow, evaluation, and grading system described herein. The processor(s) 210 is/are coupled, either directly or via appropriate intermediary hardware, to a display 250 and to one or more input/output (I/O) devices 260, such as a keypad, a touch panel sensor, a microphone, and the like. The processor(s) 210 is/are also coupled, either directly or via appropriate intermediary hardware, to the memory 220, the battery 240 and the energy transducer 245. The mobile device 110/112 may also include a transceiver 270 and a GPS receiver 280 for establishing Wi-Fi, Bluetooth and/or Near Field Communication (NFC) connectivity, as well as satellite connectivity and other telecommunication methodologies.

The energy transducer 245 may be an electromagnetic transducer configured to convert propagating electromagnetic waves to and from conducted electrical signals. The energy transducer 245 may include a coil composed of conductive material to enable the movement of electrons when a current is applied. The coil may include a port for connecting to a battery or an energy storage unit. The energy transducer 245 may also include electrical components configured to manipulate the electric energy that passes through the circuit. For example, the energy transducer 245 may include resistors, capacitors, transistors, inductors, diodes, and various types of the same class of electrical components to perform wireless power transfer by induction, as practiced by those of ordinary skill in the art.

The energy transducer 245 may also include an oscillator at a first part of the circuit to convert the fully charged battery DC signal to an AC signal that can be transferred wirelessly. At the end of the oscillator may be an inductor, which may use the AC signal generated by the oscillator to create a magnetic field that may be transferred over to a second part of the circuit. The second part of the circuit may include another inductor with an inductance that is similar to an inductance of the inductor in the first part of the circuit. The signal that may be transferred passes through a DC generator, which converts the AC signal to a DC signal that may be used to charge the second battery.

In general, wireless charging is based on the principle of magnetic resonance, or inductive power transfer. Magnetic resonance or inductive power transfer is the process of transferring an electric current between two objects using coils to induce an electromagnetic field. For example, an inductive power transfer may include an alternating current in a wire loop that generates an alternating magnetic field which in turn induces an alternating current in a nearby secondary coil. By attaching a load to the secondary coil, the induced AC current could be made to do useful work (for example, charge a battery). The magnetic field generated by the primary coil radiates (approximately equally) in all directions, hence the flux drops rapidly with distance (obeying an inverse square law). Consequently, the secondary coil must be placed as close as possible to the primary to intercept the most flux. In addition, the amount of energy the secondary coil captures is proportional to the cross section it presents to the magnetic field. The optimum cross section is offered by a secondary coil of identical dimensions to the primary, aligned parallel and with a vertical separation of just tens of millimeters. The separation, alignment and sizes of the respective coils determines the “coupling factor” which has a significant influence on the efficiency of the energy transfer.

An example for resonant power transfer is a system that transferred power between coils operating at resonant (identical) frequencies. The resonant frequencies may be determined by the coils' distributed capacitance, resistance and inductance. The resonant power transfer technique is still inductive because the oscillating magnetic field generated by the primary coil induces a current in the secondary coil, but resonant systems take advantage of a strong coupling that occurs between resonant coils, even when separated by tens of centimeters. Nonetheless, energy is transferred from one coil to the other, instead of spreading Omni-directionally from the primary coil as in the inductive example. Resonant energy transfer is not as reliant on the coils being in the same orientation, so long as the secondary coil presents a large enough cross section to the primary coil so that in each cycle, more energy is absorbed that is lost by the primary coil.

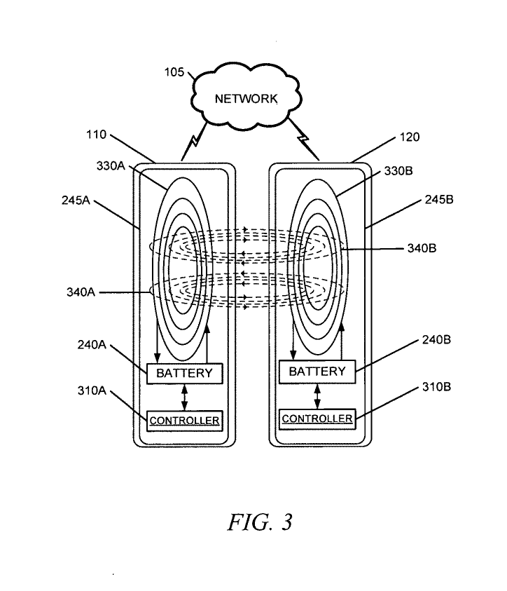

FIG. 3 is a block diagram of a system of network connected mobile devices with inductive coils executing a wireless energy transfer, according to an example embodiment. For example, a system 300 for executing wireless energy transfer between mobile devices 110/120 may include a DMD 110 connected to a network 105 and a RMD 120 connected to the network 105. The DMD 110 may be operating in a discharge mode and the RMD 120 may be operating in a recharge mode. The DMD 110 may include a first energy transducer 245A electrically coupled to a first battery 240A. The RMD 120 may include a second energy transducer 245B electrically coupled to a second battery 240B. The first energy transducer 245A may include a first coil 330A electrically coupled to the first battery 240A, such that when electrical energy is discharged from the first battery 240A, a first magnetic energy field 340A is generated around the first coil 330A. The first magnetic energy field 340A may be proportional to the electric energy that is discharged from the first battery 240A.

The first energy transducer 245A may also include a first controller 310A in communication with or electrically coupled to the battery 240A. The first controller 310A may be configured to control how the electric energy is discharged from the first battery 240A to the first coil 310A. The first controller 310A may be the processor 210 or part of the processor 210 of the mobile device 110. For example, the first controller 310A may receive instructions, which when executed, causes the energy in the first battery 240A to be discharged into the first coil 330A. The first controller 310A may also cause the first battery 240A to discharge the energy at various rates and in various quantities.

The second energy transducer 245B may include a second coil 330B electrically coupled to the second battery 240B, such that when electrical energy is discharged from the second battery 240B, a second magnetic energy field 340B is generated around the second coil 330B. The second magnetic energy field 340B may be proportional to the electric energy that is discharged from the second battery 240B.

The second energy transducer 245B may also include a second controller 310B in communication with or electrically coupled to the second battery 240B. The second controller 310B may be configured to control how the magnetic energy 340A is detected by the second energy transducer 245B. For example, the second controller 310B may receive instructions, which when executed, causes the electric energy 340A detected by the second coil 330B to be applied to the second battery 240B. The second controller 310B may also cause the energy transducer 245B to recharge the second battery 240B with electric energy or current at various rates and in various quantities. The second controller 310B may be the processor 210 or part of the processor 210 of the mobile device 120.

The second controller 310B may also be configured to control how the electric energy 340B is discharged from the second battery 240B to the second coil 310B. The second controller 310B may be the processor 210 or part of the processor 210 of the mobile device 120. For example, the second controller 310B may receive instructions, which when executed, causes the energy in the second battery 240B to be discharged into the second coil 330B. The second controller 310B may also cause the second battery 240B to discharge the energy at various rates and in various quantities. The first controller 310A may operate identical to the operation of the second controller 310B and vice versa. Furthermore, the second energy transducer 245B may operate identical to the operation of the first energy transducer 245A and vice versa.

According to another example embodiment, the system 300 for executing the transfer of energy between the DMD 110 and the RMD 120 may also include the RMD 120 being configured to transmit an energy transfer request to the network 105, wherein the energy transfer request is an indication that the battery 240B of the RMD 120 is below a pre-defined threshold. The DMD 110 may receive the energy transfer request from the network 105 when the network 105 determines that the DMD 110 is within a pre-defined proximity of the RMD 120. The DMD 110 may be configured to transmit an affirmative authorization to the RMD 120 in response to the energy transfer request, wherein the RMD 120 and the DMD 110 receive location data comprising a location. Further, in response to the DMD 110 and the RMD 120 being at the location, the DMD 110 may receive a signal causing the first energy transducer 245A to transfer energy to the second energy transducer 245B to enable charging of the second battery 240B.

The RMD 120 may be configured to operate in a recharge mode. The recharge mode may be a setting indicated on the RMD 120 that sends a notification to the network 105 that the RMD 120 has a battery capacity that is below a pre-defined threshold.

The location data may be provided to the DMD 110 and the RMD 120 if the first proximity is less than a first threshold. The DMD 110 may be configured to provide an indication of consent to the energy transfer request while in the DMD is in the discharge mode. The consent notification may be based at least on the indication of consent.

The DMD 110 may be configured to receive an energy transfer request while in the discharge mode, wherein the energy transfer request may originate from the RMD 120. The recharge mode may correspond to the RMD 120 submitting a request for a recharge.

The RMD 120 may receive the indication of consent to the energy transfer while in the recharge mode. For example, the RMD 120 may be in a recharge mode, which indicates to the system that the RMD 120 has a battery capacity that is below a pre-defined threshold. While in the recharge mode, the RMD 120 may, after transmitting an energy transfer request, receive an indication of consent corresponding to a DMD 110 agreeing to accept the energy transfer request. The user of the DMD 110 may accept the request or a DMD 110 may automatically accept the request without input from a user. The indication of consent may be sent to the RMD 120 via the network 105. The indication of consent may provide a notification to the user of the RMD 120. The notification may be an audible notification or a light flash notification. The notification may also be text or an image displayed on the display of the RMD 120.

The systems and methods described herein provide for determining that the energy transfer transaction is complete. For example, once it is determined that the battery of the RMD has received a quantity of charge that exceeds a pre-defined threshold, the RMD may transmit a notification to indicate that the energy transfer transaction is complete. The notification may be a message displayed on a display of the RMD or the DMD or both. The notification may also be an audible notification output from a speaker of the RMD or the DMD or both.

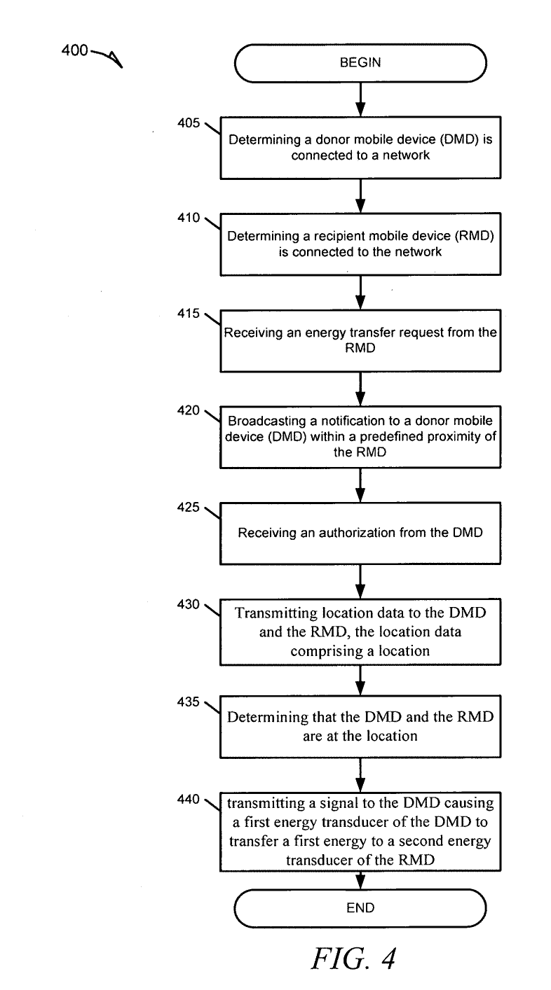

FIG. 4 is a flow chart diagram illustrating a method for executing wireless energy transfer between mobile devices connected to a network. According to an example embodiment, the method 400 may include, determining 405 a donor mobile device (DMD) is connected to a network. The method 400 may also include determining 410 a recipient mobile device (RMD) is connected to the network. Once it is determined that the DMD and the RMD are connected to the network, the method 400 may further include the network receiving 415 an energy transfer request from the RMD. In response to receiving the energy transfer request, the method may further include broadcasting 420 a notification to a DMD connected to the network. The DMD may only receive the notification if it is determined that the DMD is within a pre-defined proximity of the RMD. Alternatively, the DMD may receive the notification in other situations not limited to the RMD and DMD solely being within a pre-defined proximity. For example, the notification can be sent if the system predicts or determines that the RMD and DMD will be within a pre-defined proximity within a pre-defined period of time. The notification may correspond to the energy transfer request and may indicate that the notification is generated as a response to at least the network receiving the energy transfer request.

Continuing with the example, the method 400 may further include the network receiving 425 an authorization from the DMD, wherein the authorization may be an indication that the DMD consents to performing the energy transfer to the RMD in response to the energy transfer request. Once it is determined that the network or some other network connected device received the authorization from the DMD, the method 400 may further include transmitting 430 location data to the DMD and the RMD. The location data may comprise a location as described herein. The location data may also include instructions on how to get to the location. For example, the location data may include directions to the location.

The location data may also include instructions for directing the user(s) of the RMD 120 or DMD 110 on how to identify the user of the other DMD 110 or RMD. For example, the location instructions may include a description of the user by identifying characteristics of the user (e.g., gender, race, physical size, or wardrobe). The location instructions may also include details about the geographical location to help the user narrow down the location of the user to a more specific location within the general location. For example, the location may be an Irish Pub on Main Street and the narrowing details may be at the beer tap inside the Irish Pub on Main Street.

Continuing with the example, the method 400 may also include determining 435 that the DMD and the RMD are at the location. For example, data from the RMD and DMD may be sent to the network or network-connected devices to determine that the RMD and the DMD are at the same geographical location within a pre-defined proximity. The data may be geographical coordinates or map data corresponding to the location of the DMD and the RMD.

Once it is determined that the RMD and the DMD are at the location, the method 400 may further include transmitting 440 a signal to the DMD causing a first energy transducer electrically coupled to a first battery of the DMD to transfer a first electric energy to a second energy transducer electrically coupled to a second battery of the RMD. In this example embodiment, the location may be selected from a plurality of locations stored in a database in communication with the network, the plurality of locations may be within the pre-defined proximity of the RMD. In an example embodiment, the pre-defined proximity may be at least one of a quantity of distance measured from the location. For example, the pre-defined proximity may be a one mile radius, a half-mile radius or any other fraction of a mile or other unit of measure for distance in an n-dimensional plane. The pre-defined proximity may also be a multiple of a mile or other unit of measure for distance in an n-dimensional plane.

Continuing with the example, the method 400 may further include determining that the DMD is in a discharge mode and the RMD is in a recharge mode. For example, the discharge mode may correspond to a setting in which the DMD may be configured to indicate that the battery of the DMD is greater than a pre-defined threshold. In other words, the discharge mode may correspond to the DMD having a sufficient battery charge to transfer stored electric energy to a RMD. The user of the DMD may provide an input to the DMD to place the DMD in the discharge mode. Alternatively, the DMD may automatically be placed in the discharge mode if the battery of the DMD exceeds a pre-defined threshold. For example, the pre-defined threshold for the DMD to be in a discharge mode may be 50% battery capacity.

Continuing with the example, the method 400 may further include determining that the RMD is in a recharge mode. For example, the recharge mode may correspond to a setting in which the RMD may be configured to indicate that the battery of the RMD is less than a pre-defined threshold. In other words, the recharge mode may correspond to the RMD having less than a sufficient battery charge to perform a certain function. For example, the pre-defined threshold may be 10% battery capacity, wherein a software application installed on the RMD requires at least 10% battery capacity to complete a certain function or task. For instance, if a user would like to execute the Uber® software application to obtain transportation to a particular destination, it may be determined that the requested function of the Uber® software application requires at least 10% battery capacity to complete the requested function. Therefore, the user may place the RMD in a recharge mode to receive a battery recharge from a DMD that is within the pre-defined proximity and also operating in the discharge mode.

Continuing with the example, the method 400 may be performed so that the RMD operating in the recharge mode can be connected with a DMD in the discharge mode that is also within the pre-defined proximity of the RMD. Once connected, the method 400 may be performed to execute wireless energy transfer from the DMD to the RMD, wherein the quantity of energy transfer may be sufficient for the RMD to achieve a desired battery recharge amount.

Continuing with the example, the method 400 may further include determining that the DMD is one of a plurality of DMDs connected to the network. Even further, the method 400 may include determining that the RMD is one of a plurality of RMDs connected to the network.

Continuing with the example, the method 400 may further include wherein the notification is displayed on a display user interface of the DMD.

Continuing with the example, the method 400 may further include the signal causing the first energy transducer to transfer the first electric energy to the second energy transducer. The method 400 may further include discharging the first electric energy stored in the first battery to a first coil in the first energy transducer, wherein the discharging may further cause generating a magnetic energy around the first coil. The method 400 may further include, detecting, by a second coil in the second energy transducer, the magnetic energy and generating, by the second coil, a second electric energy based on the detecting the magnetic energy. The second electric energy may then be transferred the second battery of the RMD.

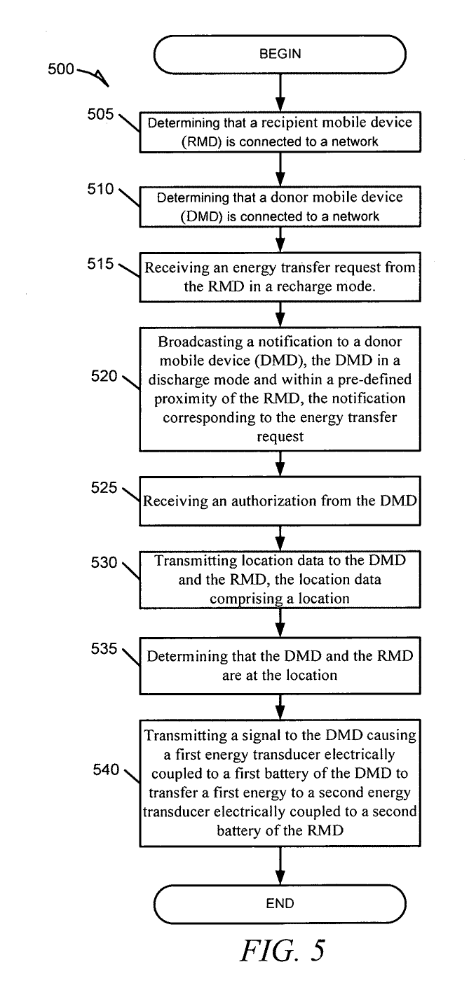

FIG. 5 is a flow chart diagram illustrating a method for executing wireless energy transfer between mobile devices connected to a network. According to an example embodiment, the method 500 may include, determining 505 a recipient mobile device (RMD) is connected to a network. Further, the method 500 may include, determining 510 a donor mobile device (DMD) is connected to the network. The method 500 may also include receiving 515 an energy transfer request from the RMD, wherein the RMD may be in a recharge mode. The method 500 may further include broadcasting 520 a notification to a DMD connected to the network, wherein the DMD is in a discharge mode. The DMD may be determined to be within a pre-defined proximity of the RMD. The notification may correspond to the energy transfer request, wherein the notification may be generated based at least on the network receiving the energy transfer request and determining that at least one DMD is connected to the network and within the pre-defined proximity to the RMD.

The DMD may only receive the notification if it is determined that the DMD is within a pre-defined proximity of the RMD. Alternatively, the DMD may receive the notification in other situations not limited to the RMD and DMD solely being within a pre-defined proximity. For example, the notification can be sent if the system predicts or determines that the RMD and DMD will be within a pre-defined proximity within a pre-defined period of time. The notification may correspond to the energy transfer request and may indicate that the notification is generated as a response to at least the network receiving the energy transfer request.

Continuing with the example, the method 500 may further include the network receiving 525 an authorization from the DMD, wherein the authorization may be an indication that the DMD consents to performing the energy transfer to the RMD in response to the energy transfer request. Once it is determined that the network or some other network connected device received the authorization from the DMD, the method 500 may further include transmitting 530 location data to the DMD and the RMD. The location data may comprise a location as described herein. The location data may also include instructions on how to get to the location. For example, the location data may include directions to the location.

The location data may also include instructions for directing the user(s) of the RMD 120 or DMD 110 on how to identify the user of the other DMD 110 or RMD. For example, the location instructions may include a description of the user by identifying characteristics of the user (e.g., gender, race, physical size, or wardrobe). The location instructions may also include details about the geographical location to help the user narrow down the location of the user to a more specific location within the general location. For example, the location may be an Irish Pub on Main Street and the narrowing details may be at the beer tap inside the Irish Pub on Main Street.

Continuing with the example, the method 500 may also include determining 535 that the DMD and the RMD are at the location. For example, data from the RMD and DMD may be sent to the network or network-connected devices to determine that the RMD and the DMD are at the same geographical location within a pre-defined proximity. The data may be geographical coordinates or map data corresponding to the location of the DMD and the RMD.

Once it is determined that the RMD and the DMD are at the location, the method 500 may further include transmitting 540 a signal to the DMD causing a first energy transducer electrically coupled to a first battery of the DMD to transfer a first electric energy to a second energy transducer electrically coupled to a second battery of the RMD. In this example embodiment, the location may be selected from a plurality of locations stored in a database in communication with the network, the plurality of locations may be within the pre-defined proximity of the RMD. In an example embodiment, the pre-defined proximity may be at least one of a quantity of distance measured from the location. For example, the pre-defined proximity may be a one mile radius, a half-mile radius or any other fraction of a mile or other unit of measure for distance in an n-dimensional plane. The pre-defined proximity may also be a multiple of a mile or other unit of measure for distance in an n-dimensional plane.

Continuing with the example, the method 500 may further include determining that the DMD is in a discharge mode and the RMD is in a recharge mode. For example, the discharge mode may correspond to a setting in which the DMD may be configured to indicate that the battery of the DMD is greater than a pre-defined threshold. In other words, the discharge mode may correspond to the DMD having a sufficient battery charge to transfer stored electric energy to a RMD. The user of the DMD may provide an input to the DMD to place the DMD in the discharge mode. Alternatively, the DMD may automatically be placed in the discharge mode if the battery of the DMD exceeds a pre-defined threshold. For example, the pre-defined threshold for the DMD to be in a discharge mode may be 50% battery capacity.

Continuing with the example, the method 500 may further include determining that the RMD is in a recharge mode. For example, the recharge mode may correspond to a setting in which the RMD may be configured to indicate that the battery of the RMD is less than a pre-defined threshold. In other words, the recharge mode may correspond to the RMD having less than a sufficient battery charge to perform a certain function. For example, the pre-defined threshold may be 10% battery capacity, wherein a software application installed on the RMD requires at least 10% battery capacity to complete a certain function or task. For instance, if a user would like to execute the Uber® software application to obtain transportation to a particular destination, it may be determined that the requested function of the Uber® software application requires at least 10% battery capacity to complete the requested function. Therefore, the user may place the RMD in a recharge mode to receive a battery recharge from a DMD that is within the pre-defined proximity and also operating in the discharge mode.

Continuing with the example, the method 500 may be performed so that the RMD operating in the recharge mode can be connected with a DMD in the discharge mode that is also within the pre-defined proximity of the RMD. Once connected, the method 500 may be performed to execute wireless energy transfer from the DMD to the RMD, wherein the quantity of energy transfer may be sufficient for the RMD to achieve a desired battery recharge amount.

Continuing with the example, the method 500 may further include determining that the DMD is one of a plurality of DMDs connected to the network. Even further, the method 500 may include determining that the RMD is one of a plurality of RMDs connected to the network.

Continuing with the example, the method 500 may further include wherein the notification is displayed on a display user interface of the DMD.

Continuing with the example, the method 500 may further include the signal causing the first energy transducer to transfer the first electric energy to the second energy transducer. The method 500 may further include discharging the first electric energy stored in the first battery to a first coil in the first energy transducer, wherein the discharging may further cause generating a magnetic energy around the first coil. The method 500 may further include, detecting, by a second coil in the second energy transducer, the magnetic energy and generating, by the second coil, a second electric energy based on the detecting the magnetic energy. The second electric energy may then be transferred the second battery of the RMD.

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments; one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

The system, wherein the AC voltage is converted to a first magnetic field that is detectable by the second energy transducer, wherein the second energy transducer converts the detected first magnetic field to a second AC voltage, wherein the second energy transducer converts the second AC voltage to a second DC voltage, the second DC voltage being applied to the second battery of the RMD 120.

In various embodiments, a hardware module may be implemented mechanically or electronically. For example, a hardware module may comprise dedicated circuitry or logic that is permanently configured (e.g., as a special-purpose processor, such as a field programmable gate array (FPGA), an application-specific integrated circuit (ASIC), or a Graphics Processing Unit (GPU)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., APIs).

Example embodiments may be implemented in digital electronic circuitry, or in computer hardware, firmware, software, or in combinations of them. Example embodiments may be implemented using a computer program product, for example, a computer program tangibly embodied in an information carrier, for example, in a machine-readable medium for execution by, or to control the operation of, data processing apparatus, for example, a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

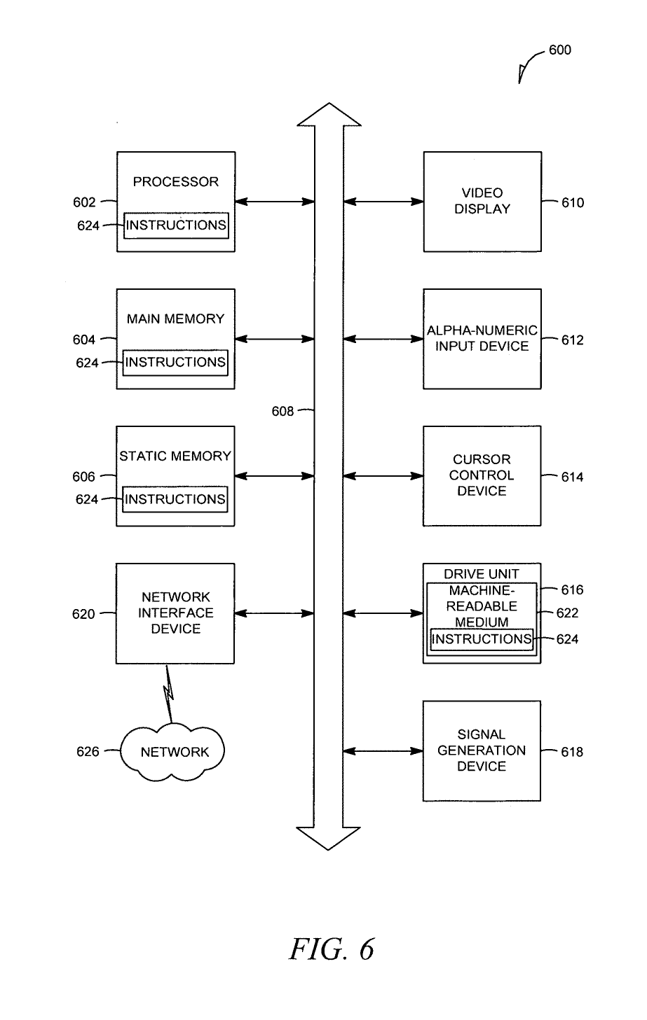

FIG. 6 is a block diagram of machine in the example form of a computer system 900 (e.g., a mobile device) within which instructions, for causing the machine (e.g., client device 110, 115, 120, 125; server 135; database server(s) 140; database(s) 130) to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a PDA, a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processor 602 (e.g., a central processing unit (CPU), a multi-core processor, and/or a graphics processing unit (GPU)), a main memory 604 and a static memory 606, which communicate with each other via a bus 608. The computer system 600 may further include a video display unit 610 (e.g., a liquid crystal display (LCD), a touch screen, or a cathode ray tube (CRT)). The computer system 600 also includes an alphanumeric input device 612 (e.g., a physical or virtual keyboard), a user interface (UI) navigation device 614 (e.g., a mouse), a disk drive unit 916, a signal generation device 618 (e.g., a speaker) and a network interface device 620.

The disk drive unit 616 includes a machine-readable medium 622 on which is stored one or more sets of instructions and data structures (e.g., software) 624 embodying or used by any one or more of the methodologies or functions described herein. The instructions 624 may also reside, completely or at least partially, within the main memory 604, static memory 606, and/or within the processor 602 during execution thereof by the computer system 600, the main memory 604 and the processor 602 also constituting machine-readable media.

While the machine-readable medium 622 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures used by or associated with such instructions. The term “machine-readable medium” shall accordingly be taken to include, but not be limited to, solid-state memories, and optical and magnetic media. Specific examples of machine-readable media include non-volatile memory, including by way of example, semiconductor memory devices (e.g., Erasable Programmable Read-Only Memory (EPROM), Electrically Erasable Programmable Read-Only Memory (EEPROM)) and flash memory devices; magnetic disks such as internal hard disks and removable disks; magneto-optical disks; and CD-ROM and DVD-ROM disks.

The instructions 624 may further be transmitted or received over a communications network 626 using a transmission medium. The instructions 624 may be transmitted using the network interface device 620 and any one of a number of well-known transfer protocols (e.g., HTTP). Examples of communication networks include a LAN, a WAN, the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

It will be appreciated that, for clarity purposes, the above description describes some embodiments with reference to different functional units or processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable mean for providing the described functionality, rather than indicative of a strict logical or physical structure or organization.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim are still deemed to fall within the scope of that claim. Moreover, in the following claims, the terms “first,” “second,” and “third” and so forth are used merely as labels, and are not intended to impose numerical requirements on their objects.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

The following description is presented to enable any person skilled in the art to create and use a computer system configuration and related method and article of manufacture to execute the wireless transfer of energy between mobile devices connected to a network. Various modifications to the example embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention may be practiced without the use of these specific details. In other instances, well-known structures and processes are shown in block diagram form in order not to obscure the description of the invention with unnecessary detail. Thus, the present disclosure is not intended to be limited to the embodiments shown, but is to be accorded the widest scope consistent with the principles and features disclosed herein.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a plurality of system elements, device components or method steps, those elements, components or steps may be replaced with a single element, component or step. Likewise, a single element, component or step may be replaced with a plurality of elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the invention. Further still, other embodiments, functions and advantages are also within the scope of the invention.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

What is claimed is:

1. A system for executing wireless energy transfer between mobile devices, the system comprising:
a donor mobile device (DMD) connected to a network, the DMD comprising a first battery electrically coupled to a first energy transducer;
a recipient mobile device (RMD) connected to the network, the RMD comprising a second battery electrically coupled to a second energy transducer;
wherein the RMD transmits an energy transfer request to the network, the network broadcasts a notification to the DMD and the network receives an authorization from the DMD in response to the energy transfer request, wherein the RMD and the DMD receive location data comprising a location; and
in response to the DMD and the RMD being at the location, the DMD receives a signal causing the first energy transducer to transfer a first electric energy to the second energy transducer.

2. The system of claim 1, wherein the DMD is in a discharge mode and the RMD is in a recharge mode.

3. The system of claim 1, wherein the DMD is one of a plurality of DMDs connected to the network.

4. The system of claim 1, wherein the RMD is one of a plurality of RMDs connected to the network.

5. The system of claim 1, wherein the notification is displayed on a user interface of the DMD.

6. The system of claim 1, wherein the location is selected from a plurality of locations stored in a database in communication with the network, the plurality of locations within the pre-defined proximity of the RMD.

7. The system of claim 1, wherein the signal causing the first energy transducer to transfer the first electric energy to the second energy transducer further causes:
the first energy transducer to discharge the first electric energy stored in the first battery to a first coil in the first energy transducer that generates a magnetic energy around the first coil; and
a second coil in the second energy transducer to detect the magnetic energy, wherein the second coil generates a second electric energy based on the magnetic energy and transfers the second electric energy to the second battery.

8. A method for executing wireless energy transfer between mobile devices, the method comprising:
receiving, by a network, an energy transfer request from a recipient mobile device (RMD) connected to the network;
broadcasting, by the network, a notification to a donor mobile device (DMD) connected to the network and within a pre-defined proximity of the RMD, the notification corresponding to the energy transfer request;
receiving, by the network, an authorization from the DMD;
transmitting, by the network, location data to the DMD and the RMD, the location data comprising a location;
determining that the DMD and the RMD are at the location; and
transmitting, by the network, a signal to the DMD causing a first energy transducer electrically coupled to a first battery of the DMD to transfer a first electric energy to a second energy transducer electrically coupled to a second battery of the RMD.

9. The method of claim 8, further comprising:
determining that the DMD is in a discharge mode and the RMD is in a recharge mode.

10. The method of claim 8, further comprising:
determining that the DMD is one of a plurality of DMDs connected to the network.

11. The method of claim 8, further comprising:
determining that the RMD is one of a plurality of RMDs connected to the network.

12. The method of claim 8, wherein the notification is displayed on a user interface of the DMD.

13. The method of claim 8, wherein the location is selected from a plurality of locations stored in a database in communication with the network, the plurality of locations within the pre-defined proximity of the RMD.

14. The method of claim 8, wherein the signal causing the first energy transducer to transfer the first electric energy to the second energy transducer further comprises:
discharging the first electric energy stored in the first battery to a first coil in the first energy transducer generating a magnetic energy around the first coil;
detecting, by a second coil in the second energy transducer, the magnetic energy;
generating, by the second coil, a second electric energy based on the detecting the magnetic energy; and
transferring the second electric energy to the second battery.

15. A non-transitory computer readable medium storing instructions executable by a processing device, wherein execution of the instructions causes the processing device to implement a method for executing wireless energy transfer between mobile devices comprising:
receiving, by a network, an energy transfer request from a recipient mobile device (RMD) connected to the network;
broadcasting, by the network, a notification to a donor mobile device (DMD) connected to the network and within a pre-defined proximity of the RMD, the notification corresponding to the energy transfer request;
receiving, by the network, an authorization from the DMD;
transmitting, by the network, location data to the DMD and the RMD, the location data comprising a location;
determining that the DMD and the RMD are at the location; and
transmitting, by the network, a signal to the DMD causing a first energy transducer electrically coupled to a first battery of the DMD to transfer a first electric energy to a second energy transducer electrically coupled to a second battery of the RMD.

16. The non-transitory computer readable medium method of claim 15, further comprising:
determining that the DMD is in a discharge mode and the RMD is in a recharge mode.

17. The non-transitory computer readable medium method of claim 15, further comprising:
determining that the DMD is one of a plurality of DMDs connected to the network.

18. The non-transitory computer readable medium method of claim 15, further comprising:
determining that the RMD is one of a plurality of RMDs connected to the network.

19. The non-transitory computer readable medium method of claim 15, wherein the location is selected from a plurality of locations stored in a database in communication with the network, the plurality of locations within the pre-defined proximity of the RMD.

20. The non-transitory computer readable medium method of claim 15, wherein the signal causing the first energy transducer to transfer the first electric energy to the second energy transducer further comprises:
discharging the first electric energy stored in the first battery to a first coil in the first energy transducer generating a magnetic energy around the first coil;
detecting, by a second coil in the second energy transducer, the magnetic energy;
generating, by the second coil, a second electric energy based on the detecting the magnetic energy; and
transferring the second electric energy to the second battery.
